(19) United States
(12) Patent Application Publication
(10) Pub. No.: US 2023/0332391 A1
(43) Pub. Date: Oct. 19, 2023

(54) Toilet Light Providing Audible Amusements

(71) Applicant: Douglas Shawn Blakeny, II, Vienna, OH (US)

(72) Inventor: Douglas Shawn Blakeny, II, Vienna, OH (US)

(21) Appl. No.: 18/134,535

(22) Filed: Apr. 13, 2023

Related U.S. Application Data
(60) Provisional application No. 63/330,355, filed on Apr. 13, 2022.

(51) Int. Cl. E03D 9/00; F21V 33/00; F21V 31/00; F21V 23/04; F21V 23/06; F21V 21/108

(52) U.S. Cl. CPC E03D 9/00; F21V 33/0052; F21V 31/00; F21V 23/0471; F21V 23/06; F21V 21/108; F21Y 2115/10

(57) ABSTRACT

A toilet light with audible amusements having a plastic enclosure/housing and a flexible section made of Nylon assembled in a manner to make it waterproof. The internal components of the device include a PCB board, metal magnet, motion sensor, nylon, battery, speaker, and additional electrical components. The housing includes a motion sensor light window covered with translucent plastic, a front led indicator, and infrared induction antenna on a top side surface, and a USB charging port accessory, which is further comprises of a silicone protector to cover the USB, and a power button. An L-shaped arm can be removable attached to the housing having a short section with connects to the body of the device and a longer section perpendicular to the short section which extends into a toilet bowel and is comprised of an LED light on the end for illuminating the toilet bowel.

### SEQUENCE LISTING OR PROGRAM

Not Applicable

### TECHNICAL FIELD OF THE INVENTION

The present invention relates to bathroom and toilet lights. More particularly, the invention relates to a light for illuminating a toilet bowel also comprising audible means for emitting amusing sounds.

### BACKGROUND OF THE INVENTION

Most people have the need to use the bathroom at least one time during the course of the night. In most instances, this requires activating the bathroom lights (e.g. incandescent or florescent lights). However, the intensity of the bathroom lights is often irritating to the eyes and causes temporary disorientation, as well as distortion of vision, particularly when a person is in a semi-sleep state in the middle of the night.

Various attempts have been made to illuminate a toilet at night for male users. In general, the prior art describes toilet seat lights which are placed in the upright position in order to activate the light source. Other prior art has the disadvantage of being activated by flushing, which requires auxiliary fluid mechanical components. Still other prior art proposes propose devices which fail to equally accommodate both male and female users.

Novelty items are meant to be amusing and provide something to lighten the mood of the observer. They also make great sources of conversation due to their unusual or quirky nature. People buy novelty items for their own homes, and, for the same reasons, novelty items are also popular gift items. In general, the more surprising or unusual the item is, the better it serves its purpose, and so new novelty products are always needed.

Therefore, a need has been established for a novelty toilet light with the ability to play amusing sounds as well as light the toilet bowel. With the conventional lighting feature, like a night light, and novelty or amusement sounds amusing for adults and kids alike, the present targets all age groups infants, children, adults, and senior citizens.

### SUMMARY OF THE INVENTION

The device of the present invention is a toilet light with audible amusements. The device of the present invention is comprised of a plastic enclosure/housing made from ABS, or PP materials and a flexible section made of Nylon assembled in a manner to make it waterproof. The internal components of the device include a PCB board, metal magnet, motion sensor, nylon, battery, speaker, and additional electrical components.

The housing includes a motion sensor light window covered with translucent plastic, a front led indicator, and infrared induction antenna on a top side surface, and a USB charging port accessory, which is further comprises of a silicone protector to cover the USB, a power button made of soft material such as rubber or silicone.

The exterior plastic shape of the body of the present invention is round, with the speaker at the front having a symmetrical pattern with holes for audio output. A translucent window in front enables a motion sensor, and a power light indicator is located above, with an infrared induction antenna at the top.

Sound output is emitted from a front surface comprising a plurality of holes aligned with the internal speaker.

The infrared motion sensor detects movement of an external object triggers amplification by the sound module. The sound module receives the sensor signal, and its sound is amplified by the speaker. The LED light receives a light sensor signal and flashes colorful lights in response to the light sensor signal. A front LED light indicator indicates that the device is in an on or off state. A power button is provided to turn the device into on or off states.

The arm has an L-shape having a short section with connects to the body of the device and a longer section perpendicular to the short section which extends into a toilet bowel and is comprised of an LED light on the end for illuminating the toilet bowel when a light sensor detects a dark condition in the room.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIGS. 1-3 are expanded/exploded view of the present invention illustrating the components parts of the device.

FIG. 4 is a top planar view of the device of the present invention illustrating the infrared sensor.

FIG. 5 is a perspective front view of the device of the present invention.

FIG. 6 is a front planar view of the device of the present invention illustrating the sensor and sound output speaker.

FIG. 7 is a side planar view of the device of the present invention illustrating the cylindrical body and securing arm.

FIGS. 8-9 are perspective back views of the device of the present invention illustrating the Power button and USB.

FIGS. 10-13 are side perspective views of the device of the present invention illustrating the component parts including the body, arm, speaker, power indicator light, infrared sensor, USB, and motion sensor window.

FIG. 14 is a front planar view of the device of the present invention.

FIG. 15 is a side planar view of the device of the present invention.

FIG. 16 is a top planar view of the device of the present invention.

FIG. 17 is a back/rear planar view of the device of the present invention.

FIG. 18 is a front perspective view of the device of the present invention.

FIG. 19 is a back/rear perspective view of the device of the present invention.

FIG. 20 is a top front perspective view of the device of the present invention.

FIG. 21 is a top rear perspective view of the device of the present invention.

FIGS. 22-25 are perspective view of the device of the present invention installed on a toilet as taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

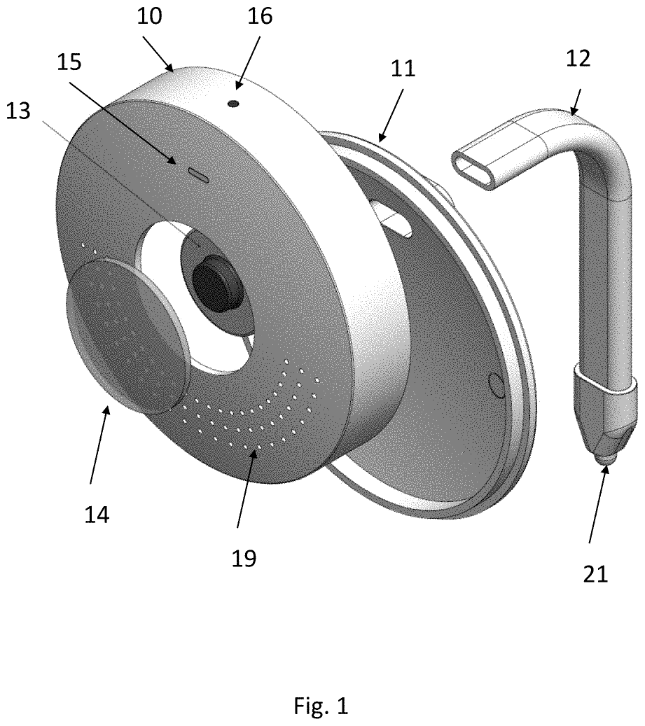

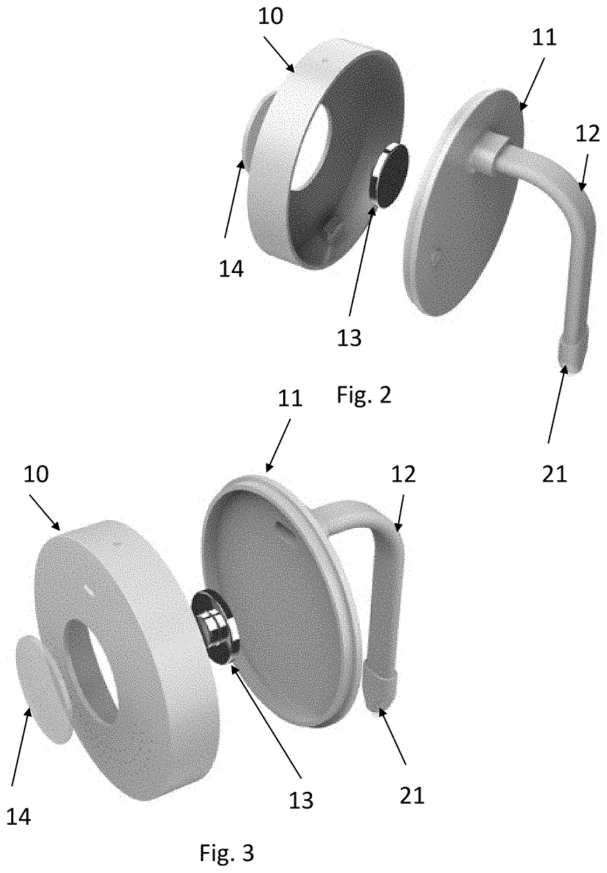

The device of the present invention is a toilet light with audible amusements. FIGS. 1-3 are expanded/exploded view of the present invention illustrating the components parts of the device. The device of the present invention is comprised of a two part plastic enclosure/housing 10 and 11 made from ABS, or PP materials and a flexible section 12 made of Nylon assembled in a manner to make it waterproof. The internal components 13 of the device include a PCB board, metal magnet, motion sensor, nylon, USB/Lithium and/or AAA batteries, speaker, and additional electrical components.

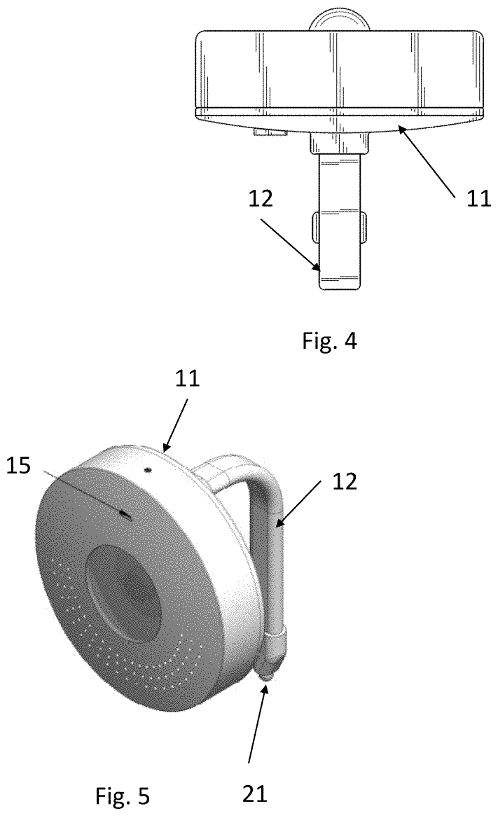

The housing 10 and 11 includes a motion sensor light window 21 covered with translucent plastic 14, a front led indicator 15, and infrared induction antenna on a top side surface, and a USB charging port accessory 17, which is further comprises of a silicone protector to cover the USB, a power button 18 made of soft material such as rubber or silicone. FIG. 4 is a top planar view of the device of the present invention illustrating the infrared motion sensor 16.

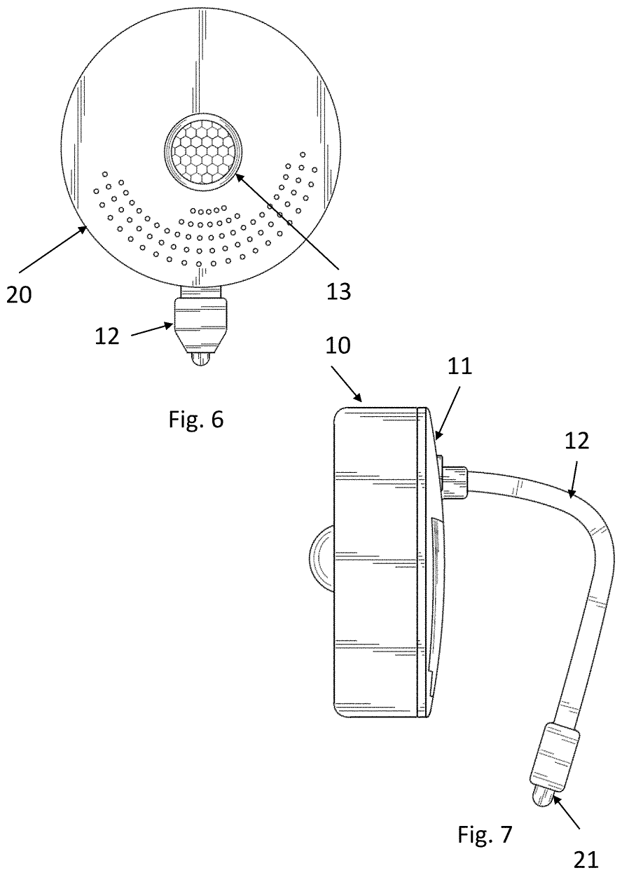

FIG. 5 is a perspective front view of the device of the present invention. Sound output is emitted from a front surface comprising a plurality of holes 19 aligned with the internal speaker 20. FIG. 6 is a front planar view of the device of the present invention illustrating the sensor 13 and sound output speaker 20.

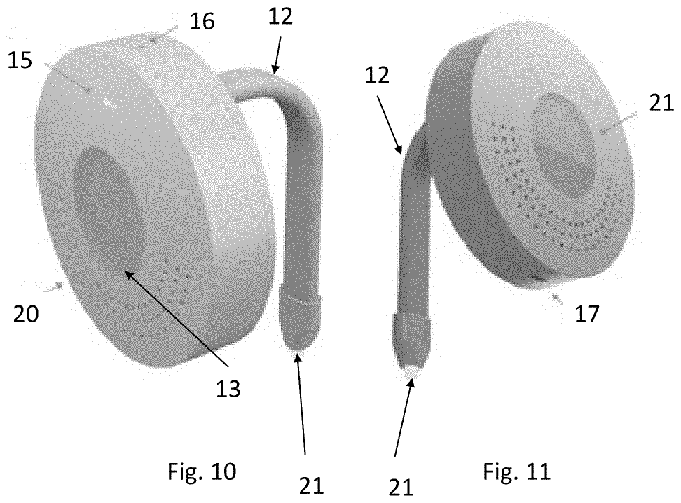

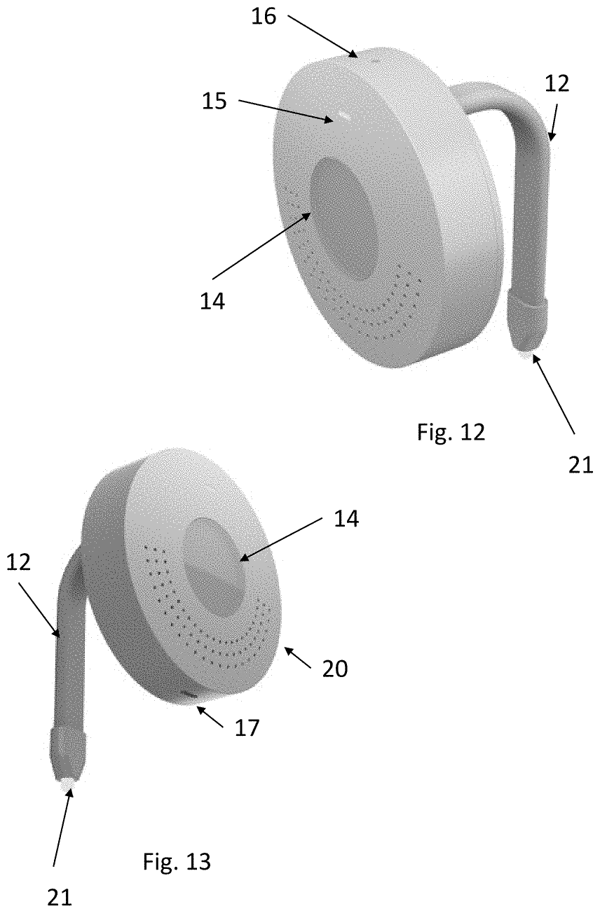

FIGS. 10-13 are side perspective views of the device of the present invention illustrating the component parts including the body 10 and 11, arm 12, speaker 20, power indicator light 15, infrared motion sensor 16, USB 17, and motion sensor window 14.

The exterior plastic shape of the body 10 and 11 of the present invention is round, with the speaker 20 at the front having a symmetrical pattern with holes 19 for audio output. A translucent window 14 in front enables a motion sensor 13, and a power light indicator 15 is located above, with an infrared induction antenna at the top.

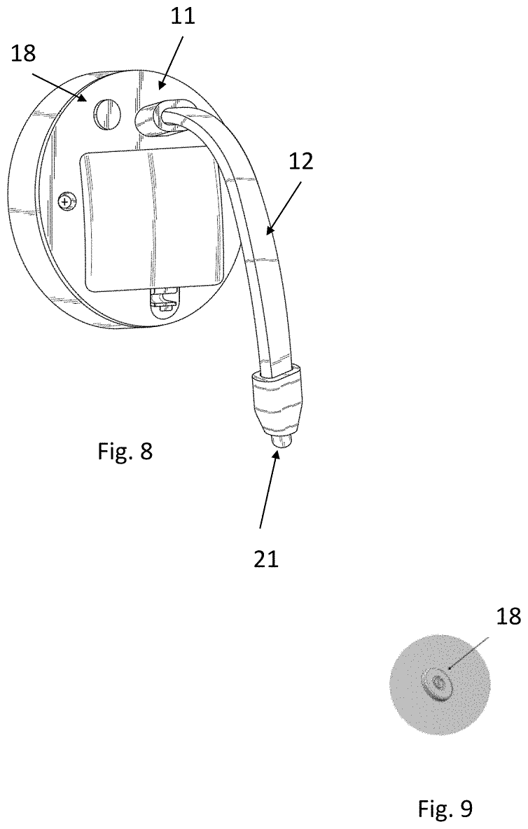

FIG. 5 is a perspective front view of the device of the present invention. FIG. 7 is a side planar view of the device of the present invention illustrating the cylindrical body 10 and 11 and securing arm 12. FIGS. 8-9 are perspective back views of the device of the present invention illustrating the Power button 18 and USB 17.

The infrared motion sensor 16 detects movement of an external object triggers amplification by the sound module. The sound module receives the sensor signal, and its sound is amplified by the speaker. The LED light 15 receives a light sensor signal and flashes colorful lights in response to the light sensor signal. A front LED light indicator 15 indicates that the device is in an on or off state. A power button 18 is provided to turn the device into on or off states.

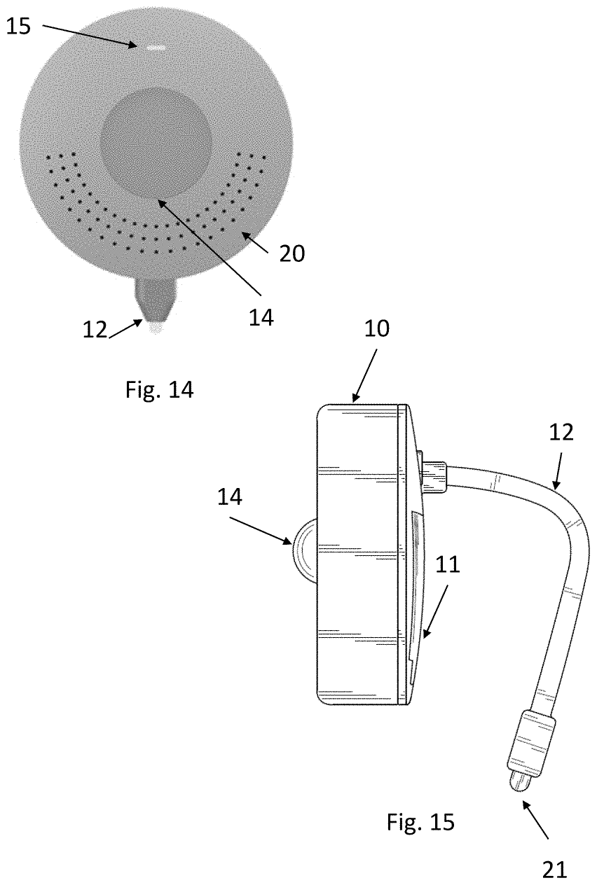

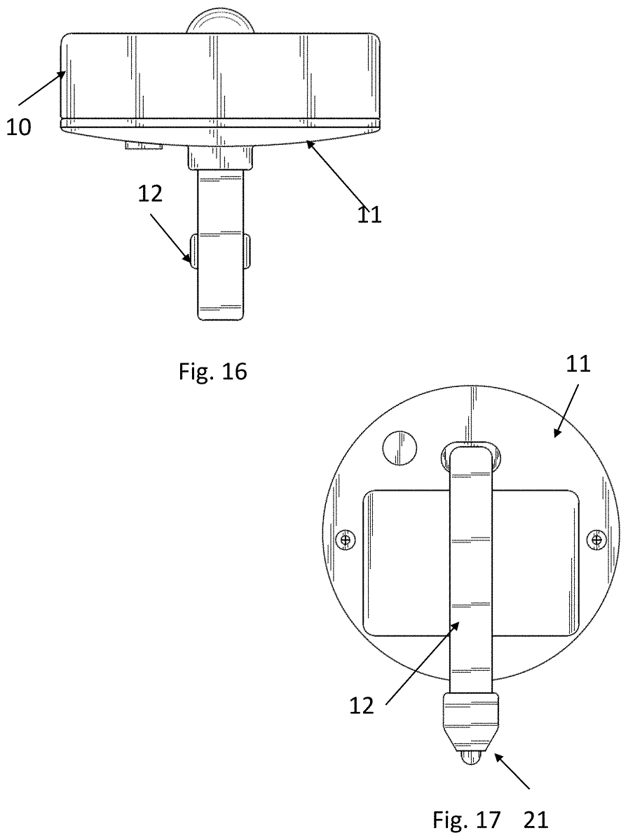

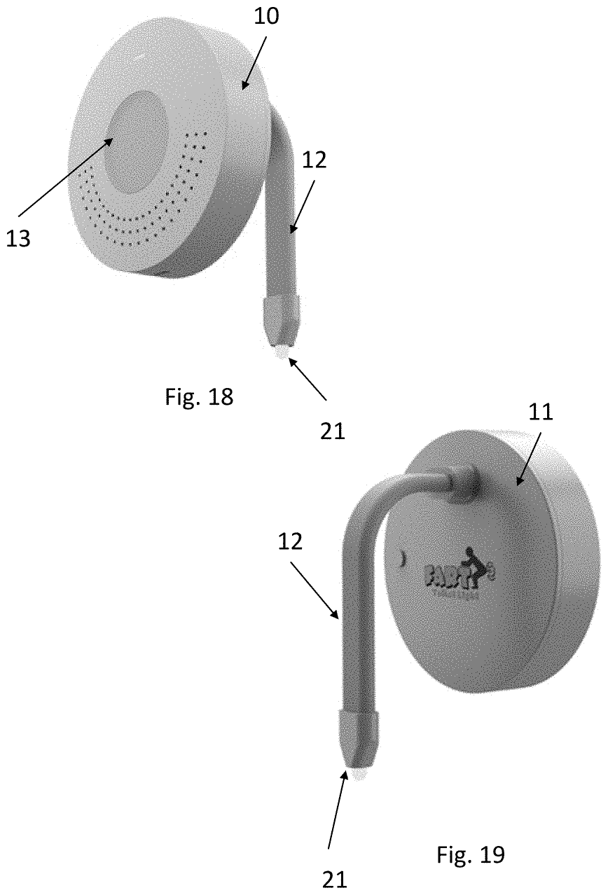

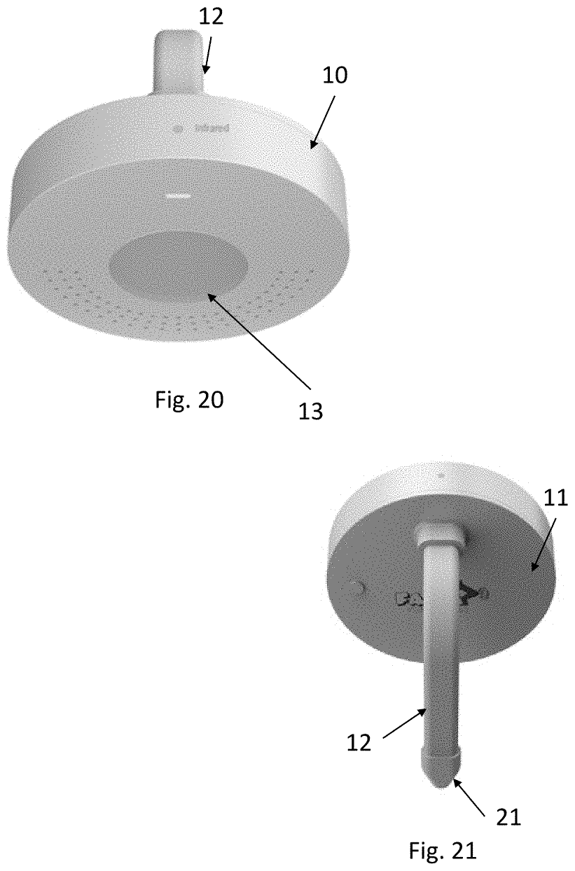

FIGS. 14-21 are various perspective and planar illustrations of the present invention which show how the arm 12 is connected to the body 10 and 11 of the device. The arm 12 can be removable attached to the housing and in one embodiment is compression fit into a receiving end of the housing but could also be molded as one piece.

The arm 12 has an L-shape having a short section with connects to the body of the device and a longer section perpendicular to the short section which extends into a toilet bowel and is comprised of an LED light on the end 21 for illuminating the toilet bowel when a light sensor detects a dark condition in the room.

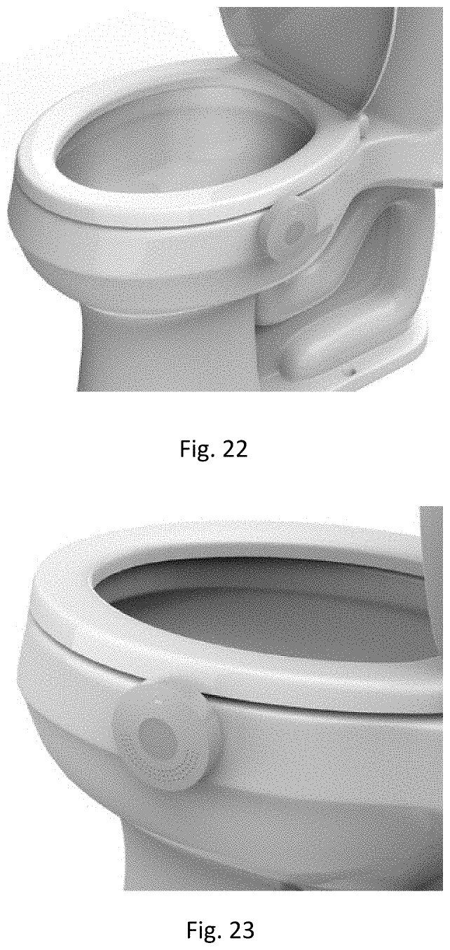

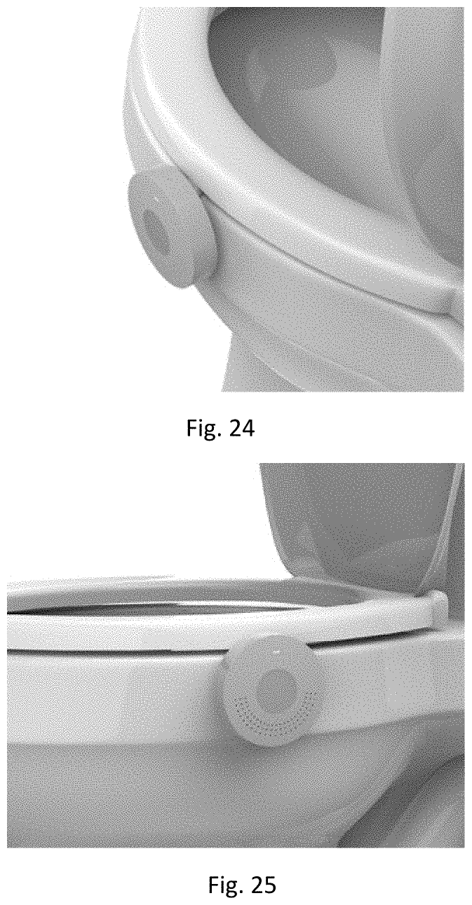

FIGS. 22-25 are perspective view of the device of the present invention installed on a toilet as taught by the present invention. As illustrated, the arm 12 of the device is placed on the interior of the toilet bowl and the housing 10 and 11 is placed on the exterior of the toilet bowel. The arm 12 holds the housing securely in place and the toilet seat, when in a down position, locks the device into position. The arm 12 extending into the toilet bowl and having an LED on its end 21 is used to illustrate the bowel as shown in FIG. 22 when the light sensor detects darkness in the room.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A toilet light with audible amusements comprising:
a plastic enclosure/housing made from ABS, or PP materials;
a flexible section made of nylon assembled in a manner to make it waterproof;
the internal components of the device include
a PCB board,
a metal magnet,
a motion sensor,
a nylon,
a battery,
a speaker, and
additional electrical components.

2. The device of claim 1, wherein
the housing includes
a motion sensor light window covered with translucent plastic,
a front led indicator,
an infrared induction antenna on a top side surface,
a USB charging port accessory, which is further comprises of a silicone protector to cover the USB,
a power button made of soft material such as rubber or silicone.

3. The device of claim 1, wherein
sound output is emitted from a front surface comprising a plurality of holes aligned with the internal speaker.

4. The device of claim 1, further comprising the component parts including the body, arm, speaker, power indicator light, infrared motion sensor, USB, and motion sensor window.

5. The device of claim 1, wherein
the exterior plastic shape of the body of the present invention is round, with the speaker at the front having a symmetrical pattern with holes for audio output.

6. The device of claim 1, wherein
a translucent window in front enables a motion sensor, and a power light indicator is located above, with an infrared induction antenna at the top.

7. The device of claim 1, wherein
the infrared motion sensor detects movement of an external object triggers amplification by the sound module;
the sound module receives the sensor signal, and its sound is amplified by the speaker;
the LED light receives a light sensor signal and flashes colorful lights in response to the light sensor signal;
a front LED light indicator indicates that the device is in an on or off state; and
a power button is provided to turn the device into on or off states.

8. The device of claim 1, wherein
the arm can be removable attached to the housing and in one embodiment is compression fit into a receiving end of the housing but could also be molded as one piece.

9. The device of claim 1, wherein
the arm has an L-shape having
a short section with connects to the body of the device, and
a longer section perpendicular to the short section which extends into a toilet bowel and is comprised of an LED light on the end for illuminating the toilet bowel when a light sensor detects a dark condition in the room.

10. The device of claim 1, wherein
the arm of the device is placed on the interior of the toilet bowl and the housing is placed on the exterior of the toilet bowel;
the arm holds the housing securely in place and the toilet seat, when in a down position, locks the device into position; and
the arm extending into the toilet bowl and having an LED on its end is used to illustrate the bowel when the light sensor detects darkness in the room.
